(19) United States
(12) Patent Application Publication
(10) Pub. No.: US 2006/0072707 A1
(43) Pub. Date: Apr. 6, 2006

(54) Method and apparatus for determining impact of faults on network service

(75) Inventors: Carlos Cesar F. Araujo, Cary, NC (US); James Horan Carey, Acton, MA (US); John E. Dinger, Cary, NC (US); Paul J. Tasillo, Holden, MA (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/955,081

(22) Filed: Sep. 30, 2004

(51) Int. Cl. H04M 1/24

(52) U.S. Cl. 379/1.01

(57) ABSTRACT

A method and apparatus is provided for reporting the impact on services in a network caused by node and network faults or outages. As a method, the operator of a specified network device is provided with notice of the impact of a network fault on one or more services running in association with the specified device. The method includes the steps of discovering one or more devices in the network that are respectively connected to the specified device, to assist in performing an intended task, and then discovering each service that is configured to run on each of the discovered devices, likewise in support of task performance. The method further comprises monitoring the status of respective discovered devices at prespecified intervals, in order to detect the occurrence of a fault in the network. Upon detecting a fault, an alert is generated, to indicate the impact of the detected fault on respective discovered services.

### BACKGROUND OF THE INVENTION

1. Technical Field

The invention disclosed and claimed herein generally relates to a method and apparatus for monitoring a network to detect faults, in order to determine the impact the faults have on prespecified services running on the network. More particularly, the invention pertains to a method of the above type for automatically discovering devices, or nodes, in the network that are coupled to a particular operator device, and also for discovering services configured to run on the discovered nodes. Even more particularly, the invention pertains to a method of the above type that alerts network operators of the effects that network outages or faults will have on the discovered services.

2. Description of Related Art

A business system disposed to operate in connection with a network such as the Internet typically requires a server that runs a particular server program, or service. Moreover, it is very common for a business system to use a server that is running one or more services in addition to the particular service. For example, a business system such as a catalog ordering system could require a server running services such as data processing systems, and also web application services. Moreover, the additional services could in turn rely on network communications with yet other services, in order to implement the business system in its entirety. Accordingly, it is seen a number of services operating at different network nodes may be required in order to implement a business system.

An operator of a business system of the above type will generally be very familiar with the particular server used to access the Internet or other network. However, the operator likely will not be aware of all the other network devices, or of the services respectively running thereon, that are required to operate the business system as described above. Thus, the impact that a network fault or outage could have on these services would also not be known to the operator. Accordingly, it would be desirable to give operators of business systems visibility into the effects of network outages, and what services are made unavailable thereby. This information would assist operators in correcting service problems caused by network outages. For example, if two server machines being operated by an operator both stopped responding, and the operator was alerted that one machine had DB2 service and the other had no services running on it, the operator could prioritize fixing the server running the DB2 service first.

In the prior art, a business systems manager is available that may show line of business impact to a operator. One such system is the Tivoli® Business Systems Manager, Tivoli® being a proprietary trademark of International Business Machines Corporation (IBM) and registered in the United States. These systems provide a higher level of service impact based on network outages. However, this prior art system requires an operator to manually define relationships among the network components required for a business system. Thus, no completely automated solution to the above problem, whereby a operator is automatically informed of the impact that a network fault has on necessary services, appears to be available at the present time.

### BRIEF SUMMARY OF THE INVENTION

By means of the invention, the service impact of node (end system) and network faults or outages is reported to network operators, based on correlating the network outages with services automatically discovered to be running on the nodes. This enables an operator to prioritize correction of service problems caused by the network outage events, based on the comparative impact of an outage on respective services. One useful embodiment of the invention is directed to a method for providing the operator of a specified network device with notice of the impact of a network fault on one or more services running in association with the specified device. The method comprises the steps of discovering one or more devices in the network that are respectively connected to the specified device, to assist in performing an intended task, and then discovering each service that is running on each of the discovered devices, likewise in support of task performance. The method further comprises monitoring the status of respective discovered devices at prespecified intervals, in order to detect the occurrence of a fault in the network. Upon detecting a fault, an alert is generated to indicate the impact of the detected fault on respective discovered services.

### BRIEF DESCRIPTION OF THE SEVERAL VIEWS OF THE DRAWINGS

The novel features believed characteristic of the invention are set forth in the appended claims. The invention itself, however, as well as a preferred mode of use, as well as further objectives and advantages thereof, will best be understood by reference to the following detailed description of an illustrative embodiment when read in conjunction with the accompanying drawings, wherein:

FIG. 1 is a schematic diagram showing a network and associated components with which an embodiment of the invention may be used.

FIG. 2 is a block diagram showing an embodiment of the invention.

FIG. 3 is a flow chart illustrating use of the embodiment of FIG. 2.

FIG. 4 is a block diagram showing a simplified control for the embodiment of FIG. 2.

### DETAILED DESCRIPTION OF THE INVENTION

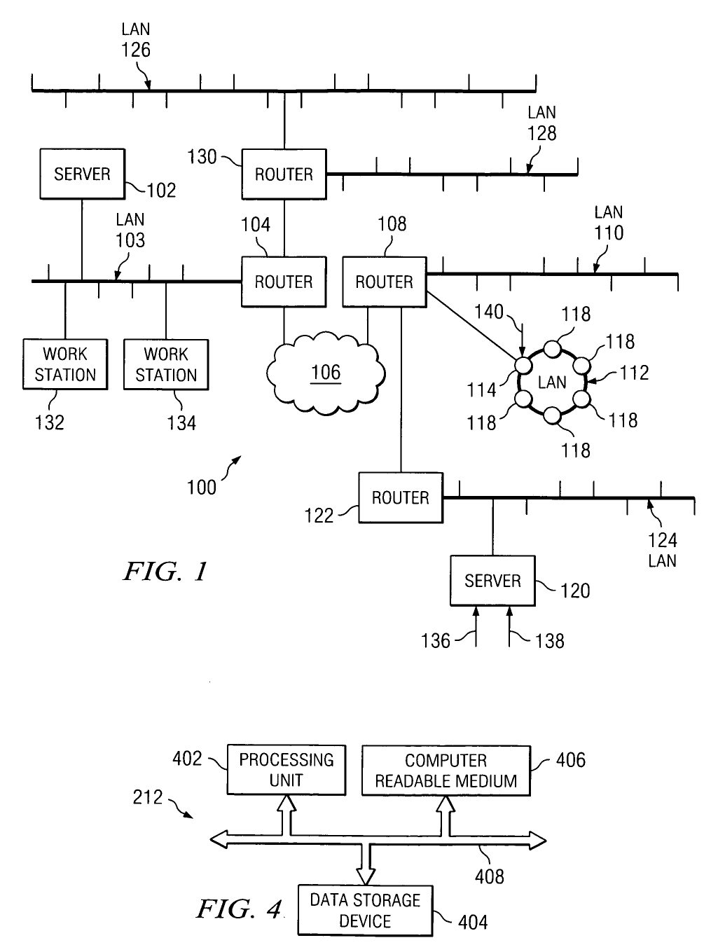

Referring to FIG. 1, there is shown a network 100 comprising the Internet, or a selected section or portion thereof, having components with which an embodiment of the invention may be used. More particularly, FIG. 1 shows a server 102 connected to a LAN 103, which also has a connection to a router 104. Server 102 is connected through LAN 103 and router 104 to a generalized Internet connection 106. Internet connection 106 is not shown in any detail, but comprises a configuration of routers and other components, as is very well known to those of the skill in the art, for interconnecting devices such as servers, workstations and the like on a global scale. Thus, server 102 is connectable to router 108, and is further connectable to respective devices or nodes (not shown) of a local area network (LAN) 110. Server 102 is also connectable through router 108 to LAN 112, having a server 114 and devices such as work stations 118 coupled thereto. Through routers 108 and 122, server 102 is connectable to a node 120, comprising a server, and to respective devices or nodes (not shown) of a LAN 124.

FIG. 1 further shows server 102 connectable through routers 104 and 130 to respective nodes (not shown) of LANs 126 and 128. Work stations 132 and 134 are shown to be devices connected to LAN 103, and may be employed by an operator to control and direct operation of server 102.

To illustrate an embodiment of the invention, it is assumed that an operator operates server 102 to establish a business system to carry out a specified task, such as catalog ordering or the like. It is further assumed that services running on server 102 for this propose must rely on other services in order to implement the entire business system. Accordingly, the operating system of server 102 establishes a connection with server 120. Server 120 is configured to run services 136 and 138, which are both required to implement the business system. A connection is also established between server 102 and server 114 of LAN 112, which is configured to run another required service 140.

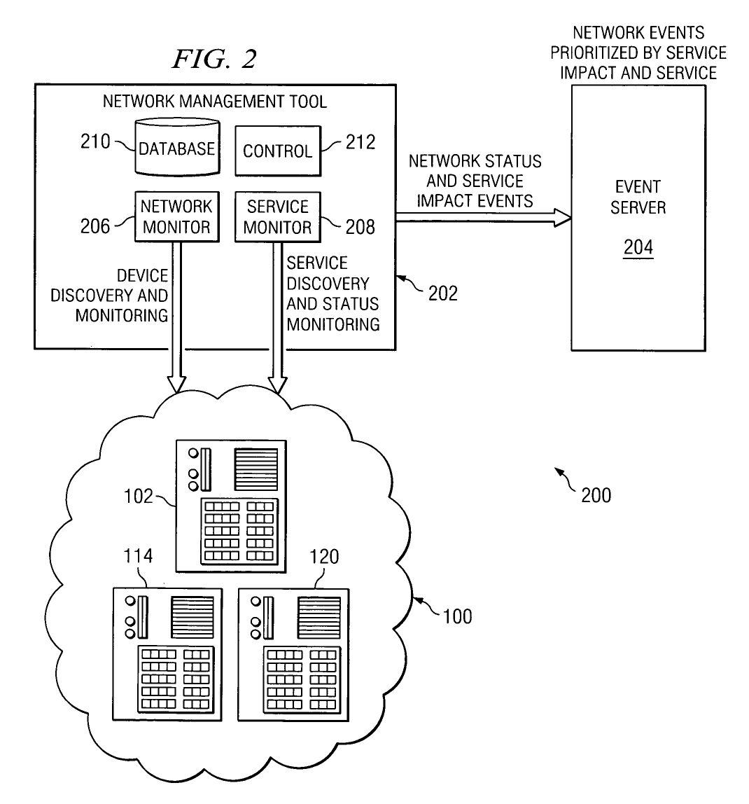

Referring to FIG. 2, there is shown a network management system 200 comprising an embodiment of the invention, wherein system 200 includes a network management tool 202 and an event server 204. The network management tool, in turn, comprises a network monitor 206 and a service monitor 208. Network management tool 202 is provided to acquire information in regard to the devices of network 100 that become connected to server 102, in order to implement the business system as described above. Tool 202 also acquires information regarding the services associated with the connected devices.

Network monitor 206 is adapted to send an ICMP (Internet Control Message Protocol) network request to server 102 over network 100, at the server IP address. The ICMP response or lack thereof, enables the monitor 206 to determine whether a machine is active on the IP address or not. Further information about the device is retrieved through SNMP (Simple Network Management Protocol) protocol requests. Thus, network monitor 206 is able to determine or discover the respective connected devices, including servers 120 and 114, as well as any other servers, routers, and work stations. Each of these discovered devices, or nodes, is then listed in a database 210 residing in network management tool 202.

After respective devices connected to server 102 have been discovered and listed in database 210, network monitor 206 continues to assess or monitor the availability status of each discovered device, at intervals, which are configurable by the operator. Thus, the network monitor 206 is able to determine when either a node (i.e. a server or workstation), or an entire network that includes any of the discovered nodes, becomes unavailable because of some fault.

It is understood that the term “network”, as used herein, may refer to both a large global network such as network 100, as well as to sections thereof and smaller networks connected thereto that include discovered devices.

Referring further to FIG. 2, there is shown a service monitor 208 provided to discover any pre-configured service or services that are running on respective discovered devices of network 100. These services may include applications such as HTTP servers or a product of IBM known as DB2.

As is known to those of skill in the art, a port is used in accordance with the TCP/IP protocol to designate a particular server program, or service, running on a network computer or the like. Thus, in order to discover a service running on a particular one of the discovered devices, the service monitor 208 is connected to the network 100, at the IP address of the particular device. The monitor 208 then attempts to connect to a port of a particular number, to determine whether or not a service associated with the particular port number is running on the particular discovered device. If a service is discovered on a particular device at the particular port number, this information is stored or listed in database 210. Thereafter, the status of the listed service will be continually monitored by service monitor 208, to determine whether or not it remains on the particular device.

After attempting to connect on the particular port number, service monitor 210 is operated to attempt to connect to other port numbers, on the same IP address of the particular device, in order to discover any other services running on such device. In like manner, service monitor 208 is operated to discover the services configured to run on each of the other discovered devices. At the conclusion of this process, database 210 will contain a complete list of all nodes or devices of network 100 that are connected to server 102 in support of the business system, as described above. Database 210 will also contain a list of all services discovered to be running on the respective discovered devices, likewise in support of the business system. Moreover, the list of discovered nodes and services is continually updated in database 210, at very frequent intervals, by operating network monitor 206 and service monitor 208 to continually monitor the status of respective nodes and services.

In other embodiments of the invention, application programmable interfaces (APIs) may also be used to discover services running on devices connected to server 102.

When the network management tool 202 discovers a network fault or outage during the continual status monitoring procedures described above, the network management system 200 will also determine whether a service on any of the network nodes is affected. In the case of a fault at a node (e.g., an end station or workstation), the network management system 200 searches the database 210 to see if any services are known to be running on the node in question. If so, these services will be affected by the network fault at this node. Accordingly, the network management tool 202 of network management system 200 is operated, to generate an alert setting forth the impact of the node fault event on these services. This alert is then sent to the management console (not shown) of the operator or operator of server 102.

In the case of an outage or fault affecting an entire network, the database 210 is searched to determine if there are any nodes within the particular network which have services running on them. If there are, then these nodes will be affected by the network fault, so that the services on these nodes will also be affected. In this case, network management system 202 generates an alert setting forth the impact of the network fault event on these services. This alert is likewise sent to the management console of the operator of server 102.

By furnishing alerts as described above to the operator of server 102, the operator is enabled to set priorities in correcting the service problems resulting from the faults.

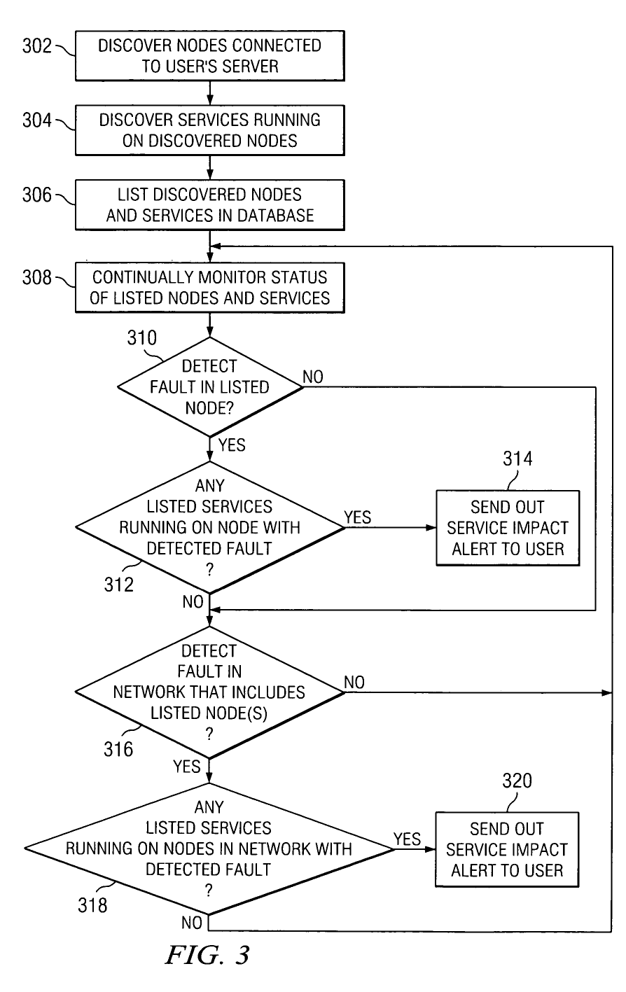

Referring to FIG. 3, there is shown a flow chart generally depicting the operation of network management system 200. Function blocks 302-306 respectively set forth the sequential steps of discovering nodes connected to an operator's server 102, discovering services that are running on discovered nodes, and listing discovered nodes and services in a database. Function block 308 indicates that the status of both listed nodes and listed services are continually monitored. The listed services are monitored, so that a service can be removed from the database when it is no longer being run on a listed nodes. The nodes are continually monitored, in order to detect any faults occurring in any of the nodes, or in any networks respectively connected thereto.

Referring further to FIG. 3, there is shown a decision block 310 directed to detection of a network fault in a listed node. When such fault is detected it is necessary to determine whether any listed services are running on the node, as indicated by decision block 312. If any such services are running, an alert indicating services affected by the node fault is sent to the operator of server 102. Decision blocks 316 and 318 and function 320 respectively indicate that similar steps occur, when a network fault affecting listed nodes and services is detected.

Referring to FIG. 4, there is shown a simplified configuration of a control 212, for the network management system 200. Control 212 comprises a processor or processing unit 402, a data storage device 404 and a computer readable medium 406. Components 402-406 are interconnected by means of a bus 408. Processing unit 402 could, for example, comprise a wide range of processors and ASIC devices. Computer readable medium 406 could comprise, for example, a recordable medium or media, such as a hard disk drive, floppy disk, a RAM, CD-ROMS, or DVD-ROMs, but is by no means limited thereto. Medium 406 is disposed to include processor instructions configured to be read by processor 402, and to thereby cause said processor to operate tool management system 200 and its respective components as described above.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing the operator of a specified network device with notice of the impact of a network fault on one or more services running on the network device, said method comprising the steps of:
discovering one or more devices included in said network that are respectively connected to said specified device to assist in performance of an intended task;
discovering each service configured to run on any of said discovered devices in support of performance of said intended tasks;
continually monitoring the status of respective discovered devices to detect occurrence of faults in said network; and
generating an alert indicating the impact of a detected fault on said discovered services.

2. The method claim 1, wherein:
said discovered devices and said specified device are respectively included in a group that includes at least servers, workstations, routers, and connections therebetween.

3. The method of claim 1, wherein:
information respectively identifying each of said discovered devices and said discovered services is maintained in a database that is continually updated.

4. The method of claim 3, wherein each of said discovered devices is associated with a node of said network and with one or more IP addresses at its associated node, and wherein:
said database contains information identifying each service running at each of said nodes at each of said IP addresses.

5. The method of claim 4, wherein:
respective devices are discovered using IP addresses contained in an operating system of said specified device.

6. The method of claim 5, wherein said step of discovering each service comprises:
establishing a TCP port connection to a selected port of said networks, wherein said TCP port connection uses an IP address of a particular one of said discovered devices; and
attempting to connect to said port to determine whether any services are running on said particular discovered device.

7. The method of claim 6, wherein:
TCP port connections are attempted for each service configured on an associated network management system.

8. The method of claim 3, wherein said fault is detected in said networks, and said alert generating step comprises:
searching said database to identify each node in said network that has any of said discovered services running on it; and
generating an alert to provide notice that any of said discovered services found to be running on said identified nodes has been impacted by said detected network fault.

9. The method of claim 3, wherein said fault is detected in a given node of said network, and said alert generating step comprises:
searching said database to determine whether or not any of said discovered services are running on said given node; and
generating an alert to provide notice that any of said discovered services found to be running on said given node has been impacted by said fault detected on said given node.

10. The method of claim 1, wherein:
said alert is sent to said operator of said specified device.

11. A computer program product in a computer readable medium for providing the operator of a specified network device with notice of the impact of a network fault on one or more services running on the network, the computer program product said comprising:
first instructions for discovering one or more devices included in said network that are respectively connected to said specified device to assist in performance of an intended task;
second instructions for discovering each service configured to run on any of said discovered devices in support of performance of said intended tasks;
third instruction for continually monitoring the status of respective discovered devices to detect occurrence of faults in said network; and
fourth instructions for generating an alert indicating the impact of a detected fault on said discovered services.

12. The computer program product claim 11, wherein:
said discovered devices and said specified device are respectively included in a group that includes at least servers, workstations, routers, and connections therebetween.

13. The computer program product of claim 11, wherein:
information respectively identifying each of said discovered devices and said discovered services is maintained in a database that is continually updated.

14. The computer program product of claim 13, wherein said fault is detected in said networks, and said fourths instruction are for:
searching said database to identify each node in said network that has any of said discovered services running on it; and
generating an alert to provide notice that any of said discovered services found to be running on said identified nodes has been impacted by said detected network fault.

15. The computer program product of claim 13, wherein said fault is detected in a given node of said network, and said fourth instructions are for:
searching said database to determine whether or not any of said discovered services are running on said given node; and
generating an alert to provide notice that any of said discovered services found to be running on said given node has been impacted by said fault detected on said given node.

16. Apparatus for providing the operator of a specified network device with notice of the impact of a network fault on one or more services running on the network, said apparatus comprising:
a network monitor disposed to discover one or more devices included in said network that are respectively connected to said specified device to assist in performance of an intended task, said network monitor being disposed further to continually monitor the status of respective discovered devices to detect occurrence of faults in said network;
a service monitor for discovering each service configured to run on any of said discovered devices in support of performance of said intended task; and
alerting means for generating an alert indicating the impact of a detected fault on said discovered services.

17. The apparatus claim 16, wherein:
said discovered devices and said specified device are respectively included in a group that includes at least servers, workstations, routers, and connections therebetween.

18. The apparatus of claim 16, wherein:
said apparatus includes a database for storing information respectively identifying each of said discovered devices and said discovered services, said information in said database being continually updated.

19. The apparatus of claim 18, wherein a detected fault occurs in said network, and wherein:
said database is searched to identify each node in said network that has any of said discovered services running on it; and
said alerting means generates an alert to provide notice that each discovered service found to be running on said identified nodes has been impacted by said detected network fault.

20. The apparatus of claim 18, wherein a detected fault occurs in a given node of said network, and wherein:
said database is searched to determine whether or not any of said discovered services are running on said given node; and
said alerting means generates an alert to provide notice that each discovered services found to be running on said given node has been impacted by said fault detected on said given node.
